(19) United States
(12) Patent Application Publication
(10) Pub. No.: US 2019/0124369 A1
(43) Pub. Date: Apr. 25, 2019

(54) VIDEO DATA DISTRIBUTOR AND AIRCRAFT CABIN MANAGEMENT SYSTEM

(71) Applicant: AIRBUS OPERATIONS GMBH, Hamburg (DE)

(72) Inventors: Michael LÜDTKE, Hamburg (DE); Christian RIEDEL, Hamburg (DE); Burkhard HEINKE, Hamburg (DE); Sven-Olaf BERKHAN, Hamburg (DE)

(21) Appl. No.: 16/162,305

(22) Filed: Oct. 16, 2018

(30) Foreign Application Priority Data
Oct. 17, 2017 (DE) 10 2017 218 515.5

(51) Int. Cl. H04N 21/214; H04N 5/232; G06F 3/14; B64D 11/00

(52) U.S. Cl. CPC H04N 21/2146; H04N 5/23238; B64D 2011/0061; B64D 11/00; G06F 3/1423

(57) ABSTRACT

A video data distributor for distribution of image and video data onboard an aircraft, has a central processing unit, at least one graphics processor coupled to the central processing unit, at least one display unit interface coupled to the graphics processor, a high-speed data transfer interface, and a buffer memory coupled to the central processing unit. An external display unit is connectable to the display unit interface. Via the high-speed data transfer interface, image and video data can be communicated from a network control device to the central processing unit. The buffer memory is designed to buffer-store image and video data received via the high-speed data transfer interface.

### CROSS-REFERENCE TO RELATED APPLICATION

This application claims priority to German Patent Application DE 10 2017 218 515.5 filed Oct. 17, 2017, the entire disclosure of which is incorporated by reference herein.

### TECHNICAL FIELD

The disclosure herein relates to a video data distributor for the synchronized distribution of image and video data to image and video data display units onboard an aircraft, to an aircraft cabin management system comprising a plurality of video data distributors, and to an aircraft comprising an aircraft cabin management system of this type.

### BACKGROUND

Dynamic image and video processing systems often require hardware components having a sufficient performance to be able to display image and video data in real time, without latency and with sufficient image quality. In order to be able to transfer image and video data with high bandwidth from processing units to display units, care is usually taken not to exceed a maximum cabling length.

In the case of a plurality of display units, use is often made of hub and spoke topologies or star topologies for network connections of the display units among one another. The image and sound data can be transferred for example by way of a transfer standard such as DisplayPort, for instance. As an alternative thereto, it is also possible to have recourse to fiber-optic transfer techniques.

However, there is a need for solutions for transferring and processing image and video data onboard aircraft in which, firstly, a sufficient bandwidth for high-resolution image and video data can be ensured and, secondly, the energy demand required for the transfer is as low as possible.

### SUMMARY

One of the objects of the disclosure herein comprises, therefore, finding improved solutions for transferring and processing image and video data onboard an aircraft.

This and other objects are achieved by a video data distributor, an aircraft cabin management system, and an aircraft having features disclosed herein.

In accordance with a first aspect of the disclosure herein, a video data distributor, in particular for the distribution of image and video data onboard an aircraft, comprises a central processing unit, at least one graphics processor coupled to the central processing unit, at least one display unit interface coupled to the graphics processor, a high-speed data transfer interface, and a buffer memory coupled to the central processing unit. An external display unit is connectable to the display unit interface. Via the high-speed data transfer interface, image and video data can be communicated from a network control device to the central processing unit. The buffer memory is designed, adapted or configured to buffer-store image and video data received via the high-speed data transfer interface.

In accordance with a second aspect of the disclosure herein, an aircraft cabin management system comprises a multiplicity or plurality of video data distributors, each having: a central processing unit; at least one graphics processor coupled to the central processing unit; at least one display unit interface coupled to the graphics processor; and a high-speed data transfer interface. The aircraft cabin management system furthermore comprises a multiplicity of external display units, which are respectively connected to one of the display unit interfaces of the video data distributors; and a network control device, which is coupled to the high-speed data transfer interface of each of the video data distributors and which is designed, adapted or configured to communicate image and video data to each of the central processing units of the video data distributors.

In accordance with a third aspect of the disclosure herein, an aircraft comprises an aircraft cabin management system in accordance with a second aspect of the disclosure herein.

One important concept of the disclosure herein comprises positioning video data distributors having local processing capacities onboard an aircraft where display units for image and/or video data are arranged. The cabling outlay from the video data distributors to the display units can be minimized as a result. Moreover, video cameras used for example for recording panoramic recordings of the external surroundings of the aircraft can be locally connected to the nearest video data distributor in each case, in order to minimize the cabling outlay for the video cameras.

The video data distributors can receive the image and video data to be displayed from a network control device of an aircraft cabin management system serving as master unit for a multiplicity of video data distributors as slave units. In this case, the network control device supplies only the content to be displayed for the display units—the driving of the display units themselves with the contents provided by the central control device is carried out locally in the respective video data distributors provided for the display units. The video data distributors therefore act as local further processing units for image and video data which have already been preprocessed in a central control device and are distributed in preprocessed form to the video data distributors.

In this case, while the network control device indeed serves as a network-wide and topologically central control device, the network composed of network control device and video data distributors is a functionally decentralized network in which the computational complexity during the processing and conditioning of image and video data is divided between the network control device and the video data distributors.

This affords the advantage that the image and video data to be displayed can be synchronized and coordinated with one another across many different display units onboard an aircraft by the network control device, but the computational load during processing and conditioning can be decentralized.

The distributor architecture according to the disclosure herein is very well suited particularly to the implementation of virtual windows in a passenger cabin of an aircraft, in which transparent windows in the cabin wall are partly or even completely replaced by electronic screens positioned in front of the cabin wall and/or by projection surfaces for digital image and video signals. In this case, the image and video data content to be displayed for virtual windows of this type can be fed into the display units respectively assigned to the virtual windows in real time, without latency and with high resolution via the video data distributors, as a result of which the impression of a “real” window that arises for the passengers can be optimized. This means that the acceptance of virtual windows on the part of the passengers can advantageously be increased.

Together with further synchronized units such as, for instance, controllable lighting, graphical display elements, acoustic reproduction units and/or aroma release devices, the distributor architecture according to the disclosure herein can contribute to the passengers onboard the aircraft feeling at greater ease. By virtue of the highly developed representation of video data, in interplay with further reproduction units from among those mentioned above, it is possible to provide synesthetic impressions for the passengers that can simulate realistic scenarios such as, for instance, sunrises or sunsets within the passenger cabin.

In accordance with some embodiments of the video data distributor according to the disclosure herein, the video data distributor can have at least one graphics processor for a video projector and at least one graphics processor for an electronic screen. This advantageously makes it possible to connect to the video data distributor different types of display unit for the implementation of virtual windows in a passenger cabin of an aircraft.

In accordance with some embodiments of the video data distributor according to the disclosure herein, the video data distributor can have an energy supply interface, via which the video data distributor can be supplied with electrical energy by an external power supply. This ensures a high redundancy and fail-safety in the power supply of the video data distributors.

In accordance with some embodiments of the video data distributor according to the disclosure herein, the external power supply can comprise a 28 V DC voltage source or a 115 V AC voltage source. These voltage values are often readily available in an aircraft.

In accordance with some embodiments of the video data distributor according to the disclosure herein, the video data distributor can comprise at least one video camera interface via which a video camera is connectable to the video data distributor. This advantageously reduces the cabling outlay for video cameras in the external region of the aircraft since the video data distributors can be positioned in each case in local proximity to the installation sites of the video cameras.

In accordance with some embodiments of the video data distributor according to the disclosure herein, the video camera can be designed, adapted or configured to record panoramic video recordings of the surroundings of an aircraft. Such panoramic video recordings can be strung together by suitable algorithmic stitching or blending to form display sequences such that passengers observing the virtual windows are given the impression as though the aircraft fuselage were actually transparent in this region.

In accordance with some embodiments of the video data distributor according to the disclosure herein, the video camera interface can have a Power-over-Ethernet interface (PoE interface). As a result, the energy supply of the video cameras can be carried out via the video data distributor, with the result that separate power cables for the video cameras no longer become necessary.

In accordance with some embodiments of the aircraft cabin management system according to the disclosure herein, the aircraft cabin management system can furthermore comprise an image and video data memory, which is implemented in the network control device and which is designed, adapted or configured to store pre-processed image and video data for transfer to the video data distributors. Such an image and video data memory can comprise complete display scenarios, such as, for example, the image and video sequence succession for simulating specific moods, weather situations or similar natural events such as sunsets or sunrises.

In accordance with some embodiments of the aircraft cabin management system according to the disclosure herein, the video data distributors can be coupled to the network control device in a daisy chain topology, a star topology or a hub and spoke topology. In this case the video data distributors can also serve as relaying nodes which if appropriate distribute image and video data further to adjacent nodes.

The above configurations and developments can, if expedient, be combined with one another in any desired manner. Further possible configurations, developments and implementations of the disclosure herein also encompass not explicitly mentioned combinations of features of the disclosure herein described above or below in relation to the exemplary embodiments. In particular, here the person skilled in the art will also add individual aspects as improvements or supplementations to the respective basic form of the disclosure herein.

### BRIEF DESCRIPTION OF THE DRAWINGS

The disclosure herein is explained in greater detail below on the basis of the exemplary embodiments indicated in the schematic, example figures, in which here:

FIG. 1 shows a schematic block diagram of an excerpt from an aircraft cabin management system in accordance with an embodiment of the disclosure herein,

FIG. 2 shows a schematic detail view of a video data distributor in accordance with a further embodiment of the disclosure herein, which video data distributor can be used in an aircraft cabin management system,

FIG. 3 shows a schematic block diagram of an excerpt from an aircraft cabin management system in accordance with a further embodiment of the disclosure herein,

FIG. 4 shows a schematic block diagram of an excerpt from an aircraft cabin management system in accordance with a further embodiment of the disclosure herein, and

FIG. 5 shows a schematic illustration of an aircraft comprising an aircraft cabin management system from any of FIGS. 1, 3 and 4 in accordance with a further embodiment of the disclosure herein.

The accompanying figures are intended to impart a further understanding of the embodiments of the disclosure herein. They illustrate embodiments and in association with the description serve to explain principles and concepts of the disclosure herein. Other embodiments and many of the advantages mentioned are evident in view of the drawings. The elements in the drawings are not necessarily shown in a manner true to scale with respect to one another. Direction-indicating terminology such as, for instance, “at the top”, “at the bottom”, “left”, “right”, “above”, “below”, “horizontal”, “vertical”, “at the front”, “at the back” and similar indications are used only for explanatory purposes and do not serve to restrict the generality to specific configurations as shown in the figures.

In the figures of the drawing, identical, functionally identical and identically acting elements, features and components—unless explained otherwise—are provided in each case with the same reference signs.

### DETAILED DESCRIPTION

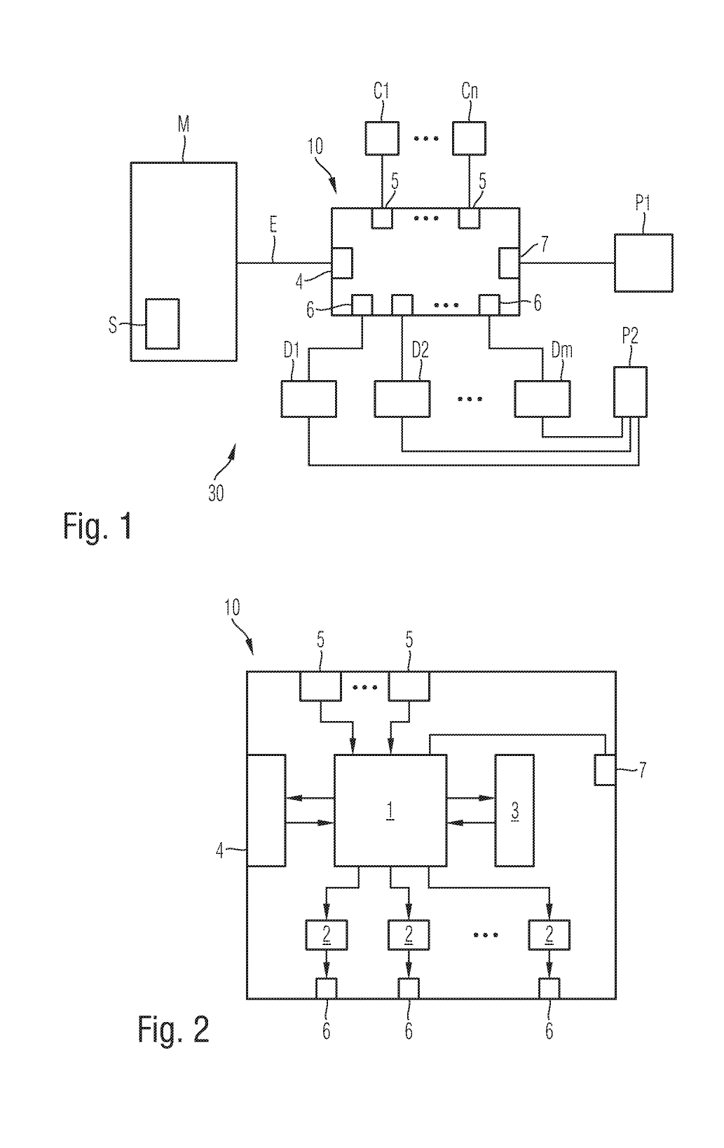

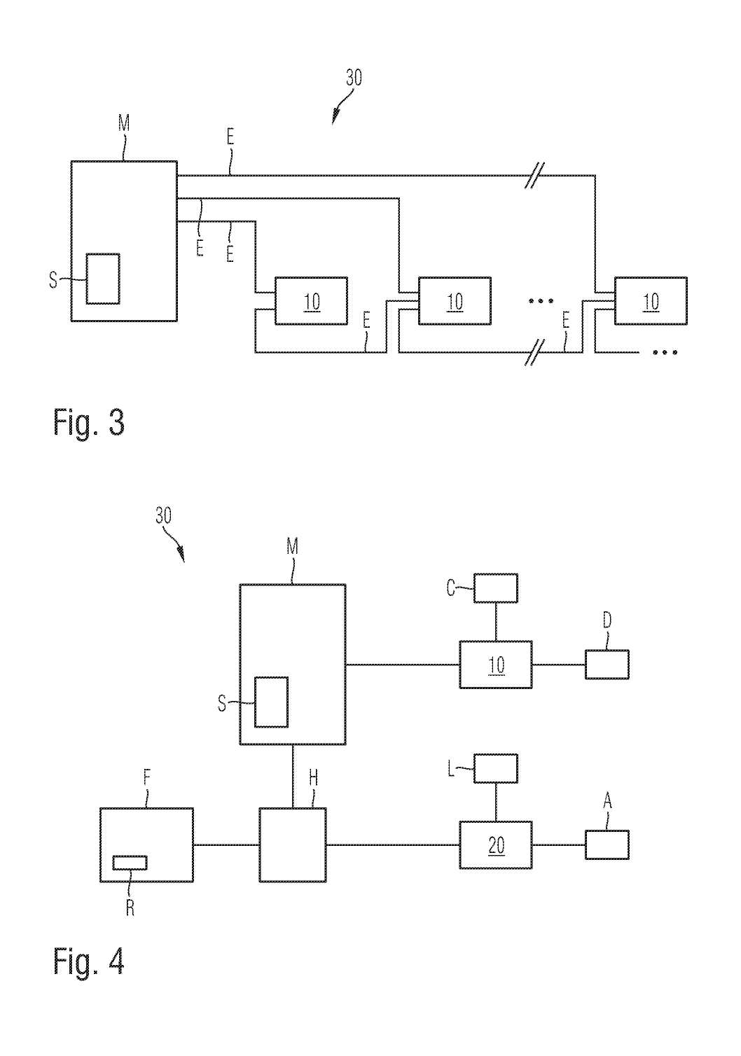

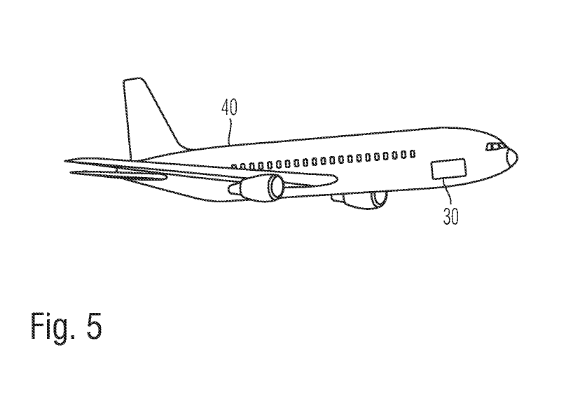

FIG. 1 shows an excerpt from an aircraft cabin management system 30 comprising a central control device M and a video data distributor 10 connected to the central control device. The aircraft cabin management system 30—in the same way as the aircraft cabin management systems 30 in FIGS. 3 and 4 as described further below—can be used in passenger cabins of aircraft, such as, for example, in the aircraft 40 illustrated schematically in FIG. 5. In this case, an aircraft 40 can have one or a plurality of such aircraft cabin management systems 30. By way of example, in an aircraft 40 in which an aircraft cabin management system 30 explained with reference to FIGS. 1 to 4 is used, it is possible to implement an arrangement composed of virtual windows with the aid of electronic screens installed at the cabin wall and/or projection surfaces illuminated by image projectors on the cabin wall. It goes without saying that the positioning of display units in the passenger cabin of the aircraft 40 is not restricted to the cabin wall—additional or alternative display units can be installed for example at the cabin ceiling, at the cabin floor, in a manner freely suspended between the rows of passenger seats, or in some other way.

The network control device M serves for coordinating and synchronizing all connected video data distributors 10, such that the image and video data to be displayed by the video data distributors give passengers in the aircraft a coherent and particularly realistic impression. The network control device M can have an image and video data memory S implemented therein, such as, for instance, a solid-state memory (“solid-state drive”, SSD), which is designed, adapted or configured to store preprocessed image and video data for transfer to the video data distributors.

The construction of the video data distributors 10 is illustrated by way of example with a higher degree of detail in FIG. 2. A video data distributor 10 comprises a central processing unit 1 (CPU), which also executes the operating system for the operation of the video data distributor 10. At least one graphics processor 2 is coupled to the central processing unit 1. Three graphics processors 2 are illustrated by way of example in the example in FIG. 2. It should be clear, however, that more or fewer than three graphics processors 2 can also be implemented in the video data distributors 10. Each of the graphics processors 2 is controlled and supplied with corresponding image and video data by the central processing unit 1. The data are processed by the graphics processors 2 and provided via graphics drivers to display unit interfaces 6.

In each case different external display units can be connected to the display unit interfaces 6, for example an electronic screen D1 arranged at a cabin wall of the passenger cabin of an aircraft, or a video projector D2 designed, adapted or configured to project corresponding image and video signals onto a projection surface, for example at the cabin wall or the cabin ceiling. Even though three display units are illustrated in the example in FIG. 2, it should be clear that the number m of display units Dm is not restricted to three.

The image and video data provided to the video data distributors 10 by the network control device M are fed in at a high-speed data transfer interface 4 such as, for instance, a high-speed Ethernet interface or an interface based on optical fibers, HCS fibers or polymer optical fibers (POF) and are communicated to the central processing unit 1. The data fed in via the high-speed data transfer interface 4 can be buffer-stored in a buffer memory 3 coupled to the central processing unit 1 in order to compensate for propagation time differences and to compensate for fluctuations in the transfer bandwidth.

Via an energy supply interface 7, the video data distributor 10 can be supplied with electrical energy by an external power supply P1, for example a 28 V DC voltage source or a 115 V AC voltage source. The display units D1, . . . , Dm can be supplied with electrical energy via a separate energy supply P2, as illustrated in FIG. 2. Alternatively, a common energy supply for the video data distributor 10 and the display units D1, . . . , Dm can also be provided.

The video data distributor 10 can have at least one video camera interface 5, via which a respective video camera C1, . . . , Cn can be connected to the video data distributor 10, for example via a Power-over-Ethernet interface (PoE). The video cameras C1, . . . , Cn can comprise for example pinhole cameras, cameras having a fisheye lens or wide-angle lens cameras. In any case the image and video data from the video cameras C1, . . . , Cn can be received via the central processing unit 1 of the video data distributor 10 and be forwarded via the Ethernet connection E to the network control device M for further processing. As an alternative thereto, the video cameras C1, . . . , Cn can also be connected via separate cabling directly to the network control device M, such that preprocessing by the video data distributors 10 is not necessary.

The video cameras C1, . . . , Cn can be designed, adapted or configured to record panoramic video recordings of the surroundings of an aircraft, which are then in turn conditioned by the network control device M, for example by dividing the panoramic video recordings depending on the viewing angle. The conditioned panoramic video recordings can then be forwarded in a suitable manner to the video data distributors 10 in order to be able to reproduce as realistic an image of the aircraft surroundings as possible on the display units D1, . . . , Dm.

FIG. 3 illustrates a schematic block diagram in which an aircraft cabin management system 30 has a multiplicity of video data distributors 10 which are coupled to the network control device M in an Ethernet network with Ethernet connections E for example in a daisy chain topology, star topology or hub and spoke topology. The video data distributors 10 can, if appropriate, also be coupled among one another, for example to the locally nearest neighbour in each case via the high-speed data transfer interfaces 4.

FIG. 4 furthermore shows that besides the already explained components of the network control device M, the video data distributors 10, the video cameras C and the display units D, the aircraft cabin management system 30 can furthermore have a cabin management controller H provided for controlling further output units arranged in the cabin, such as, for instance, lighting L (for example LEDs or cabin lighting) and acoustic output units A (for example loudspeakers or headphones for passengers). The cabin management controller H drives the output units L and/or A via decoding/encoding units 20 (DEU) distributed locally in each case in the cabin of the aircraft.

Moreover, the cabin management controller H can receive inputs from a flight attendant interface F, which can have a memory R for presettings and configuration files in a similar manner to the network control device M.

The cabin management controller H is communicatively connected to the network control device M, such that the video data distributors 10 and the DEUs 20 can be synchronized and supplied with control signals in coordination with one another. This makes possible, for example, a coordinated output of, firstly, image and video data and, secondly, specific matching sounds or light impressions. As a result, by way of example, a sunset can be simulated realistically in the passenger cabin.

In the detailed description above, various features have been combined in one or more examples in order to improve the rigorousness of the illustration. It should be clear here, however, that the above description is of merely illustrative, but in no way restrictive nature. It serves to cover all alternatives, modifications and equivalents of the various features and exemplary embodiments. Many other examples will be immediately and directly clear to the person skilled in the art on the basis of the latter's technical knowledge in view of the above description.

The exemplary embodiments have been chosen and described in order to be able to present the principles underlying the disclosure herein and their application possibilities in practice in the best possible way. As a result, those skilled in the art can optimally modify and utilize the disclosure herein and its various exemplary embodiments with regard to the intended purpose of use. In the claims and the description, the terms “including” and “having” are used as neutral linguistic concepts for the corresponding terms “comprising”. Furthermore, use of the terms “a”, “an” and “one” shall not in principle exclude a plurality of features and components described in this way.

The subject matter disclosed herein can be implemented in software in combination with hardware and/or firmware. For example, the subject matter described herein can be implemented in software executed by a processor or processing unit. In one exemplary implementation, the subject matter described herein can be implemented using a computer readable medium having stored thereon computer executable instructions that when executed by a processor of a computer control the computer to perform steps. Exemplary computer readable mediums suitable for implementing the subject matter described herein include non-transitory devices, such as disk memory devices, chip memory devices, programmable logic devices, and application specific integrated circuits. In addition, a computer readable medium that implements the subject matter described herein can be located on a single device or computing platform or can be distributed across multiple devices or computing platforms.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a”, “an” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. A video data distributor for distribution of image and video data onboard an aircraft, comprising:
a central processing unit;
at least one graphics processor coupled to the central processing unit;
at least one display unit interface which is coupled to the graphics processor and to which an external display unit is connectable;
a high-speed data transfer interface, via which image and video data can be communicated from a network control device to the central processing unit; and
a buffer memory coupled to the central processing unit to buffer-store image and video data received via the high-speed data transfer interface.

2. The video data distributor according to claim 1, wherein the video data distributor comprises at least one graphics processor for a video projector and at least one graphics processor for an electronic screen.

3. The video data distributor according to claim 1, comprising an energy supply interface, via which the video data distributor can be supplied with electrical energy by an external power supply.

4. The video data distributor according to claim 3, wherein the external power supply comprises a 28 V DC voltage source or a 115 VAC voltage source.

5. The video data distributor according to claim 1, comprising at least one video camera interface via which a video camera is connectable to the video data distributor.

6. The video data distributor according to claim 5, wherein the video camera is adapted to record panoramic video recordings of surroundings of an aircraft.

7. The video data distributor according to claim 5, wherein the video camera interface has a Power-over-Ethernet (PoE) interface.

8. An aircraft cabin management system, comprising:
a plurality of video data distributors, each comprising:
a central processing unit;
at least one graphics processor coupled to the central processing unit;
at least one display unit interface coupled to the graphics processor; and
a high-speed data transfer interface;
a plurality of external display units, which are respectively connected to one of the at least one display unit interface of the video data distributors; and
a network control device, which is coupled to the high-speed data transfer interface of each of the video data distributors and which is adapted to communicate image and video data to each of the central processing units of the video data distributors.

9. The aircraft cabin management system according to claim 8, comprising an image and video data memory, which is implemented in the network control device and which is adapted to store preprocessed image and video data for transfer to the video data distributors.

10. The aircraft cabin management system according to claim 8, wherein the video data distributors are coupled to the network control device in a daisy chain topology, a star topology or a hub and spoke topology.

11. An aircraft comprising an aircraft cabin management system according to claim 8.
